(19) United States
(12) Patent Application Publication
(10) Pub. No.: US 2014/0305042 A1
(43) Pub. Date: Oct. 16, 2014

(54) PRECISION HANDHELD SEEDER

(71) Applicant: Earl Clark Weber, Sherwood, OR (US)

(72) Inventor: Earl Clark Weber, Sherwood, OR (US)

(21) Appl. No.: 13/862,566

(22) Filed: Apr. 15, 2013

(51) Int. Cl. A01C 7/02

(52) U.S. Cl. CPC A01C 7/02
USPC 47/1.1 R

(57) ABSTRACT

A trigger activated apparatus capable of easily and efficiently placing an individual pelleted or non-pelleted seed into a small tray, soil cube, soil plug, and the like particularly capable of selecting a single seed from a seed hopper and placing it accurately into a small tray, soil cube, or plug such as used by both commercial and hobby farmers.

### BACKGROUND OF THE INVENTION

1. Field of the Invention

The present invention generally relates to a hand-held trigger activated apparatus capable of easily and efficiently placing an individual pelleted or non-pelleted seed into a small tray, soil cube, soil plug, and the like. More specifically, the present invention relates to a hand-held trigger activated apparatus capable of selecting a single seed from a seed hopper and placing it accurately into a small tray, soil cube, soil plug, and the like such as used by both commercial and hobby farmers.

2. Description of the Related Art

Many people use handheld seeders to facilitate the planting of seeds. Available seeders, however, may not reliably isolate small seeds or allow people to accurately deposit the seeds in small containers, specifically small planting tray cells used by commercial growers and home gardeners. Additionally, hand seeding can be slow and tedious and can be imprecise in terms of selection, especially for small seeds. Hand seeding can also be inaccurate for depositing seeds in small cells, soil cubes, peat pots, and the like.

There are a number of patented hand seeders but they are not designed to accomplish the selecting and depositing of a single seed into a small seedling tray or soil cube. For example, U.S. Pat. No. 3,994,422 issued Nov. 30, 1976 to Thompson which teaches a hand-held seed planter for dispensing and precisely depositing charges (multiple) seeds simultaneously on a prepared seedbed in a predetermined spaced relationship. More particularly this teaching is best suited to use by a home gardener in planting varied types of seeds in a small garden plot.

As known is a hand-held and operated seeder apparatus as taught in U.S. Pat. No. 4,290,374 issued Sep. 22, 1981 to Maples which teaches an apparatus suitable for simultaneously broadcasting multiple seeds onto a particular area of ground. The broadcasting of the seeds is done via a rotating seed dispenser means as opposed to an oscillating one.

U.S. Pat. No. 5,414,955 issued May 16, 1995 to Morin teaches a hand-held seeder utilizing a vacuum creating device and a vibrating device to pick up seeds from a hopper and then dispense them through a plurality of seed placement tips into small trays or soil plugs. Also, known are hand- held tray type seeders which utilize shaking by the user to move seeds from a dish like tray down a spout to drop into a small tray or onto a soil cube or plug. In both of these types of hand-held seeders providing a single seed in each tray or soil cube or plug is difficult to ensure.

U.S. Design Pat. No. Des. 275,070 issued Aug. 14, 1984 to Brown discloses a design for a hand-held manual crank operated broadcast seeder. This teaching discloses that the device has a rotating seed dispenser not an oscillating one.

### DISCLOSURE OF THE INVENTION

The present invention provides advantages and alternatives over the prior art by providing a hand-held trigger activated seeder which easily provides a single seed of a desired size to an accurate location onto or into a tray, soil cube, or soil plug.

More particularly, the present invention resides in the ability to place a single desired sized seed into a small tray or soil cube by hand repeatedly using a pistol style handle and spring loaded trigger mechanism which oscillates the seed entrainment disc.

One object of the present invention is to provide a hand-held trigger activated device which is easy to use and removes much of the tedium and difficulty of correctly placing single seeds into large numbers of individual tray cells, soil cubes, or soil plugs.

Still another object of the present invention is to provide an oscillating seed entrainment disc that rotates through a desired arc upon depression of the trigger assembly and is automatically returned through said desired arc upon release of said trigger assembly.

Another object of the present invention is to provide a relatively inexpensive, easy to use, and suitably low maintenance hand seeder.

Yet another object of the present invention provides a seed entrainment and deposition device comprised of a handheld framework with a seed hopper and trigger activated disc that rotates a sufficient amount of distance to move a seed into a seed port, down a seed chute and into the soil. The rotation is actuated by a spring-loaded trigger that moves the disc so that it can deliver the seed, and then reverts back to the starting position. Different size seeds are accommodated by the availability of three different size seed pockets along the perimeter of the seed disc as well as the ability to change seed discs. At the end of the axle is a locking tensioning knob that keeps the seed disc flush with the face plate. Said knob can be also used to select the appropriate size seed pocket.

A further object of the present invention is providing a hand seeder for repeatedly placing single seeds into small tray cells, soil cubes, and soil plugs comprising in cooperative combination: a first side body portion having seed disc mounting race bore, a trigger mounting bore and in cooperative combination with a second side body portion a seed deposition port; a second side body portion having seed disc mounting race bore, a trigger pivot mounting bore, and in cooperative combination with said first side body portion a seed deposition port; a trigger unit comprising a body, a pair of trigger pivots, a seed disc gear, and a return spring, a seed entrainment disc having a plurality of seed pockets, a rotation gear, and a mounting shaft; a seed hopper having a seed loading aperture; and a locking tensioning knob; thereby allowing for the repeated placement of single seeds into individual small tray cells, soil cubes and soil plugs.

A yet further object of the present invention is providing a hand seeder for repeatedly placing single seeds into small tray cells, soil cubes, soil plugs, and the like comprising in cooperative combination: a first side body portion having seed disc mounting race bore a trigger mounting bore, and in cooperative combination with a second side body portion a seed deposition port, and further having a chute defining, in cooperative combination with said seed entrainment disc 5, said seed dispenser pockets; a second side body portion having seed disc mounting race bore, a trigger pivot mounting bore, and in cooperative combination with said first side body portion a seed deposition port; a trigger unit comprising a body, a pair of trigger pivots, a seed disc gear, and a return spring; a seed entrainment disc having, in cooperative combination with said first side body portion, a plurality of seed dispensing pockets, a rotation gear, a mounting shaft, and a locking tensioning knob.

A complete understanding of the present invention may be obtained from the drawings and detailed description that follow.

### BRIEF DESCRIPTION OF THE DRAWINGS

FIG. 1 shows a perspective exploded view of one preferred embodiment of the present invention.

FIG. 2 shows a plan left-hand first side view of one preferred embodiment of the present invention.

FIG. 3 shows a plan right-hand second side view of one preferred embodiment of the present invention.

FIG. 4 shows a perspective first surface view of the seed entrainment disc of one preferred embodiment of the invention of FIG. 1.

FIG. 5 shows a perspective second surface view of the seed entrainment disc of one preferred embodiment of the invention of FIG. 1.

FIG. 6 shows a perspective exploded view of another preferred embodiment of the present invention.

FIG. 7 shows a plan view of the outside/top surface said left-hand first side of a preferred embodiment of the present invention.

FIG. 8 shows a plan view of the inside/bottom surface said left-hand first side of a preferred embodiment of the present invention.

### DESCRIPTION OF THE PREFERRED EMBODIMENTS OF THE INVENTION

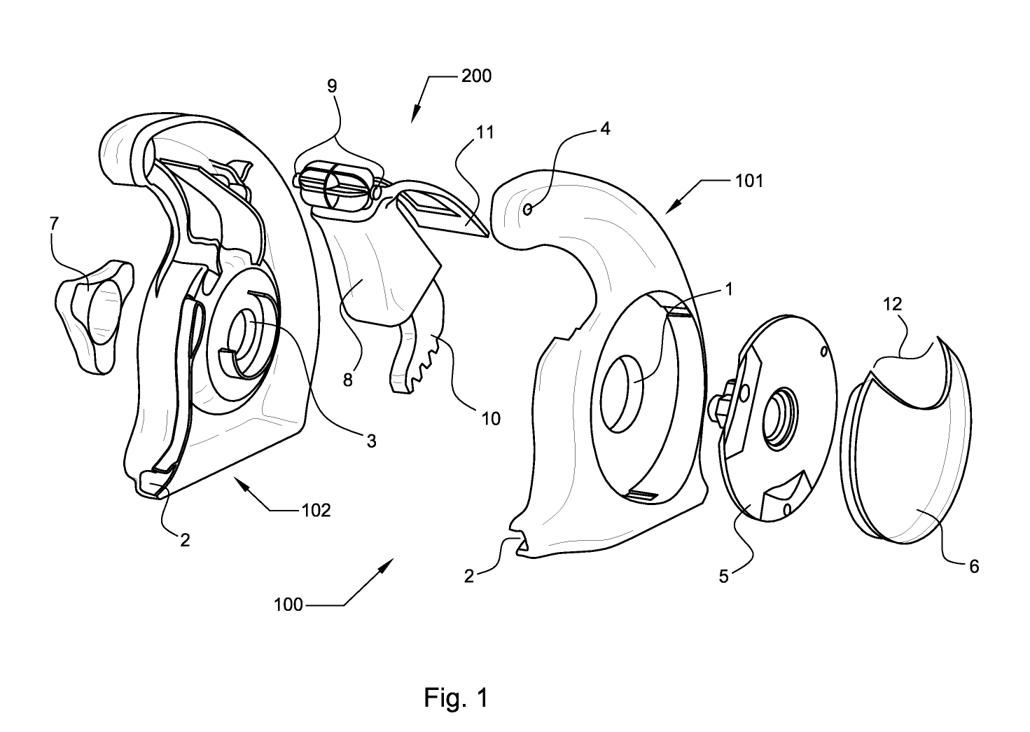

Reference will now be made to the drawings wherein to the extent possible like reference numerals are utilized to designate like components throughout the various views. Referring to FIG. 1, there is presented a perspective exploded view of one preferred embodiment of the claimed invention 100 comprising a first side body portion 101, a second side body portion 102, a trigger unit 200, a seed entrainment disc 5, a seed hopper 6 having a seed loading aperture 12, and a locking tensioning knob 7. Said a first side body portion 101 further comprising a seed disc mounting race bore 1, a trigger pivot mounting bore 4, and in cooperative combination with a second side body portion 102 a seed deposition port 2. Similarly, said a second side body portion 102 comprises seed disc mounting race bore 3, a trigger pivot mounting bore 4 (see FIG. 3), and in cooperative combination with a first side body portion 101 a seed deposition port 2. Further shown is trigger unit 200 comprises body 8, trigger pivots 9, seed disc gear 10, and return spring 11.

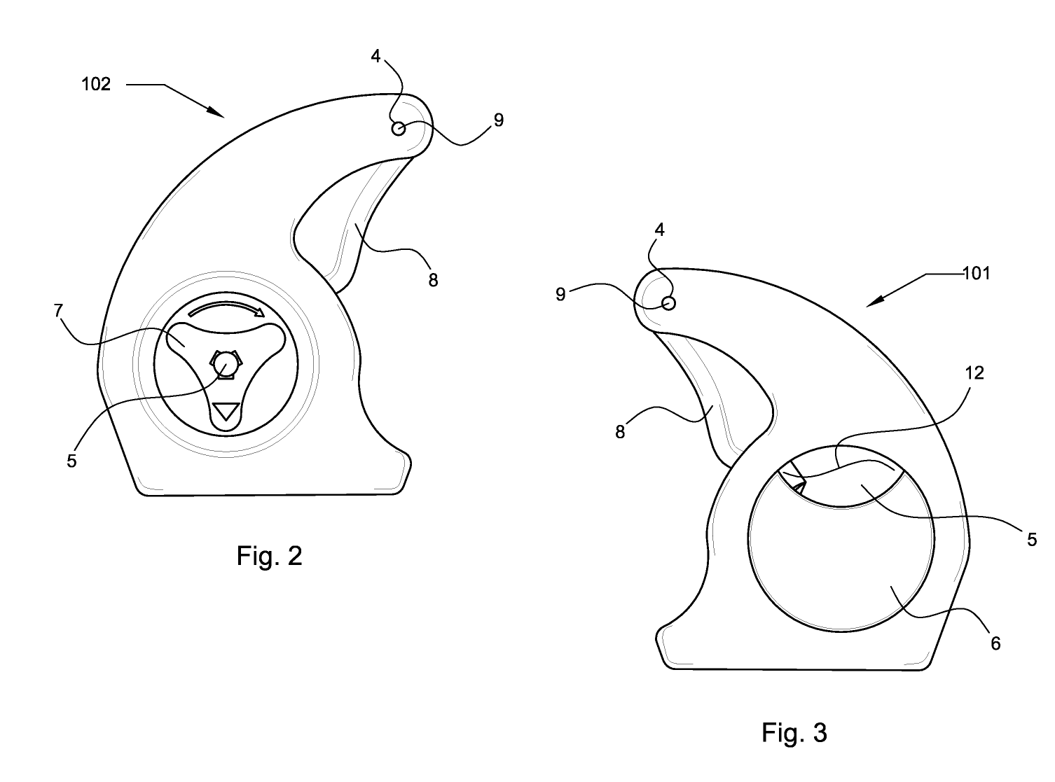

In FIG. 2 there is presented a plan second side view of a preferred embodiment of the claimed hand-seeder comprising said second side body portion 102 with trigger 8 mounted via trigger pivot 9 in trigger mounting bore 4 as well as seed entrainment disc 5 mounted by means of locking tensioning knob 7.

FIG. 3 shows a plan first side view of a preferred embodiment of the claimed hand-seeder comprising a first side body portion 101 with trigger 8 mounted via trigger pivot 9 in trigger mounting bore 4 as well as seed entrainment disc 5 and seed hopper 6.

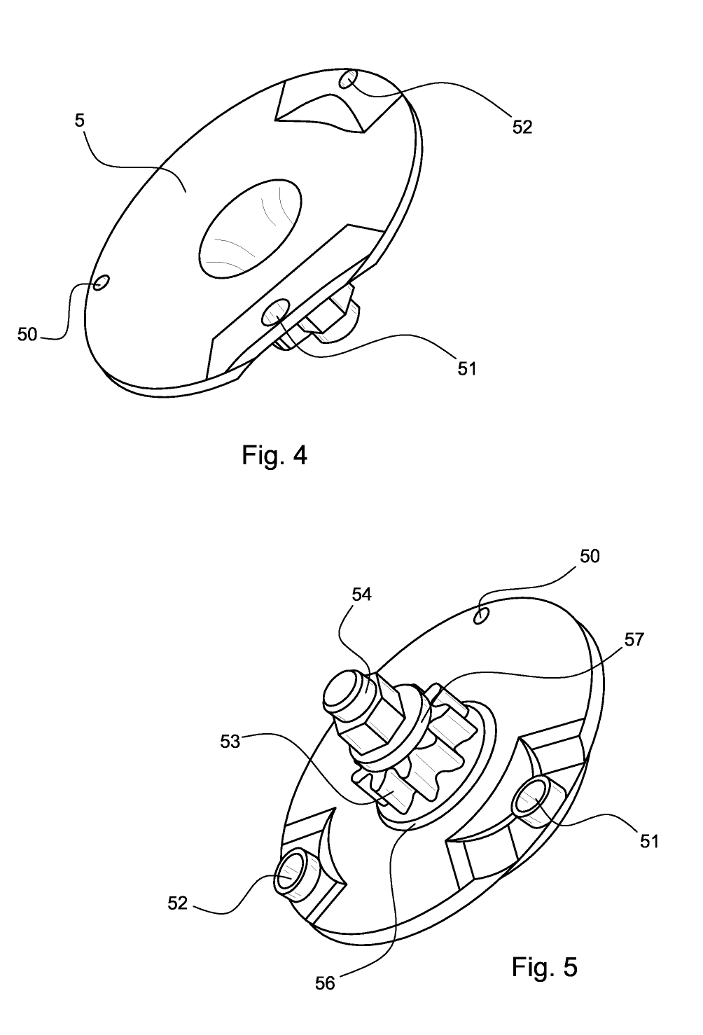

In FIG. 4 is presented a perspective first surface view of a preferred embodiment of said seed entrainment disc 5 of said hand-held seeder 100 having seed pockets 50, 51 and 52.

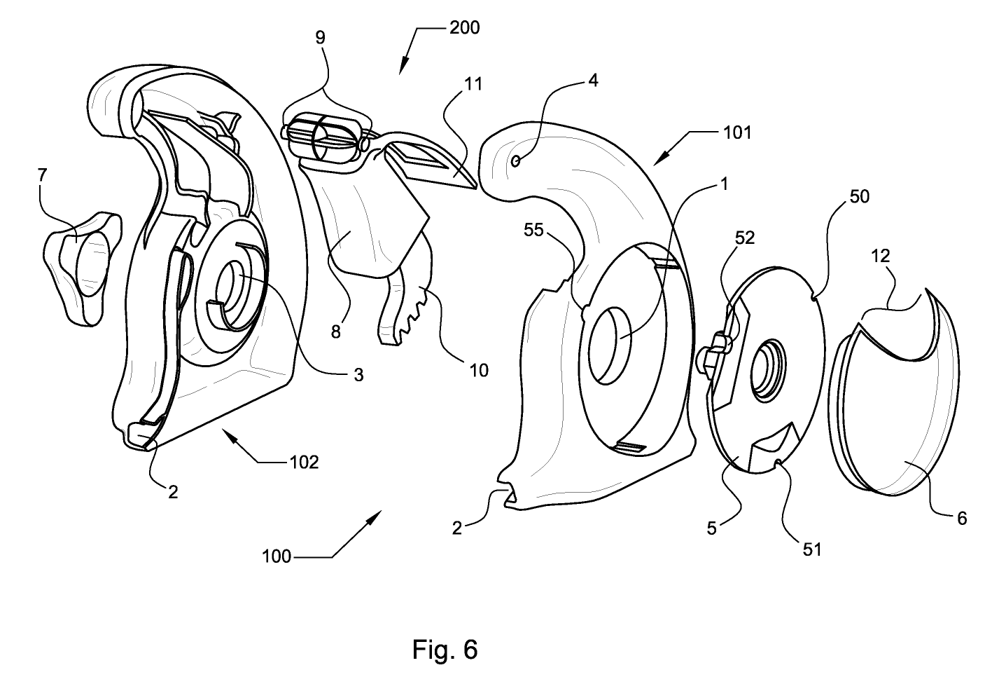

Turning to FIG. 5 there is presented a perspective second surface view of a preferred embodiment of said seed entrainment disc 5 of said hand-held seeder 100 having seed pockets 50, 51 and 52, rotation gear 53, mounting shaft 54, and bearings 56 and 57.

In FIG. 6 there is presented a perspective exploded view of a second preferred embodiment of the claimed invention 100 comprising a first side body portion 101, a second side body portion 102, a trigger unit 200, a seed entrainment disc 5, a seed hopper 6 having a seed loading aperture 12, and a locking tensioning knob 7. Said a first side body portion 101 further comprising a seed disc mounting race bore 1, a trigger pivot mounting bore 4 (see FIG. 3), and in cooperative combination with a second side body portion 102 a seed deposition port 2, and further having a partial seed pocket 55 defining, in cooperative combination with said seed entrainment disc 5, said partial seed pockets 50, 51 and 52. Similarly, said a second side body portion 102 comprises seed disc mounting race bore 3, a trigger pivot mounting bore 4, and in cooperative combination with a first side body portion 101 a seed deposition port 2. Further shown is trigger unit 200 comprises body 8, trigger pivots 9, seed disc gear 10, and return spring 11.

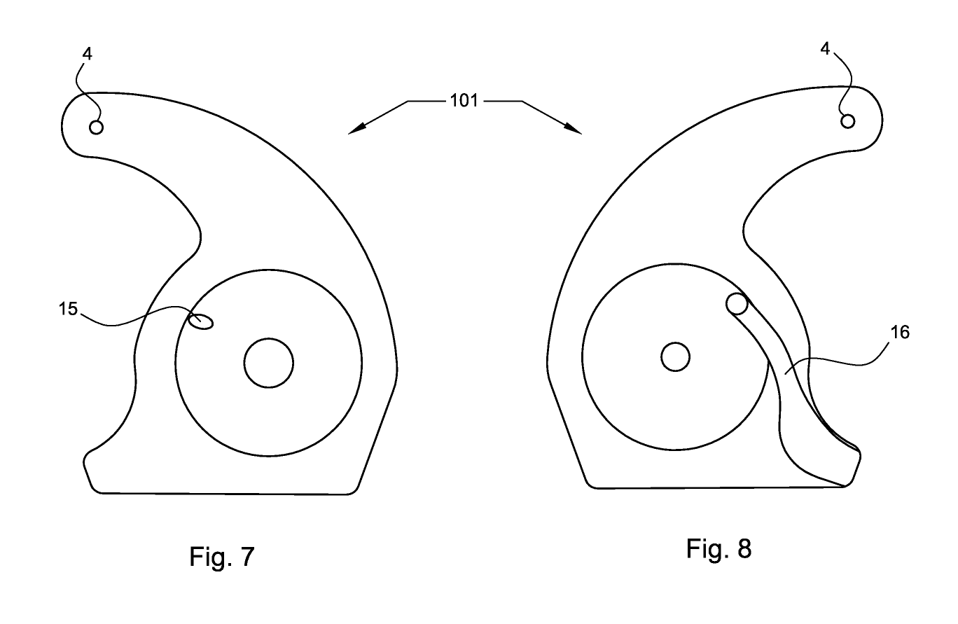

FIG. 7 presents a plan top view of first side body portion 101 showing seed deposition bore 15 as well as trigger pivot mounting bore 4.

Finally, in FIG. 8 there is presented a plan inside view of first side body portion 101 showing the seed chute 16 as well as trigger pivot mounting bore 4. A cooperating seed deposition chute 16 is provided in second side body portion 102 (not shown).

Presently preferred materials for the construction of the trigger activated hand-seeder are moldable durable, ultraviolet resistant plastic resin materials. Particularly presently preferred materials include, for example, polycarbonate, nylon, ABS, PVC, and Delrin® brand acetal resins. Most particularly presently preferred materials are transparent polycarbonate for the hopper and body portions; and a durable acetal resin for the moving parts.

In practice the claimed trigger activated hand-seeder provides a seed entrainment and deposition device comprised of a handheld framework with a seed hopper 6 and disc 5 that rotates a sufficient amount of distance to move a seed into a seed port 15, down a seed chute 16, and seed port 2 into the soil. The rotation is actuated by a spring-loaded trigger 8 that moves the disc 5 so that it can deliver the seed, and then reverts back to the starting position. Because the seed disc oscillates rather than rotating in a continuous direction there can be a plurality or seed pockets along the perimeter of said discs, 50, 51, and 52. A locking tensioning knob on the end of the seed disc axle can be used to rotate said disc and thus position the appropriate size seed pocket in the lower portion of the seed hopper in proximity to the seeds. Said knob also holds the seed disc flush with said first body portion and holds the said first and said second body portions together. Pushing the end of said axle disengages said knob if disassembly is required. Disassembly also provides an opportunity to install a different seed disc 5 with different size seed pockets 50, 51, and 52, and thus further increase the size range of seeds accommodated by said seeder 100. The present invention can provide users with a fast, easy, and convenient way to deposit pelleted and non-pelleted seeds in soil or into very small seed container, such as planting trays and micro soil blocks. The device can be used by both commercial growers and home gardeners.

In practice the present invention is held in the palm of the hand with the trigger portion positioned between the thumb and forefinger. The seed deposition port 2 positioned at the edge of the palm next to the little finger. Using a desired finger, the trigger is depressed causing the seed entrainment disc 5 to rotate in a first direction until the user selected seed pocket 50, 51, or 52 aligns with the seed chute entry port 15 thus allowing the entrained seed to drop down seed chute 16, exit the seeder via seed deposition port 2 and become deposited into a small seed tray, soil cube, soil plug, or the like. Releasing the trigger 8 allows the seed entrainment disc 5 to reverse direction via trigger return spring 11 to the starting position. Back and forth oscillating motion provides for repeated placing of seeds one at time into individual small trays, or the like. Thus, the seed entrainment disc 5 need not rotate through a complete revolution to return to a ready state for depositing the next seed, but instead need only oscillate through a sufficient arc to allow the chosen seed pocket to entrain and dispense a seed.

It is to be understood to those in the art that the presently claimed invention may have a seed disc and a hopper on each side thus increasing the size range of pelleted and non-pelleted seeds loaded into said claimed invention.

Although the preferred embodiments of the present invention have been disclosed; various changes and modifications may be made without departing from the scope of the invention as set forth in the appended claims.

What is claimed is:

1. A trigger activated hand seeder for repeatedly placing single pelleted and non-pelleted seeds into small tray cells, soil cubes, soil plugs, and the like comprising in cooperative combination:
a first side body portion having seed disc mounting race bore, a trigger mounting bore and in cooperative combination with a second side body portion a seed chute and a seed deposition port;
a second side body portion having seed disc mounting race bore, a trigger pivot mounting bore, and in cooperative combination with said first side body portion a seed chute and a seed deposition port;
a trigger unit comprising a body, a pair of trigger pivots, a seed disc gear, and a return spring;
a seed entrainment disc having a plurality of seed pockets, a rotation gear, and a mounting shaft;
a seed hopper having a seed loading aperture; and
a locking tensioning knob;
thereby allowing for the repeated placement of single seeds into individual small tray cells, soil cubes and soil plugs.

2. The trigger activated hand seeder for repeatedly placing single pelleted and non-pelleted seeds into small tray cells, soil cubes, and the like as claimed in claim 1 wherein said seed entrainment disc has bearings mounting said seed entrainment disc to said first side body and said second side body portions.

3. The trigger activated hand seeder for repeatedly placing single pelleted and non-pelleted seeds into small tray cells, soil cubes, and the like as claimed in claim 1 wherein said hand seeder is composed of molded durable, ultraviolet resistant plastic resin materials selected from the group comprising polycarbonate, nylon, ABS, PVC, and Delrin.

4. The trigger activated hand seeder for repeatedly placing single pelleted and non-pelleted seeds into small tray cells, soil cubes, and the like as claimed in claim 1 wherein said seed entrainment disc in cooperative combination with said locking tensioning knob provides for rotation of said locking tensioning knob thereby providing a means to displace the trigger gear a sufficient number of cogs of said rotation gear allowing a desired seed pocket to be selected to receive seeds from said seed hopper.

5. A trigger activated hand seeder for repeatedly placing single pelleted and non-pelleted seeds into small tray cells, soil cubes, soil plugs, and the like comprising in cooperative combination:
a first side body portion having seed disc mounting race bore a trigger mounting bore and in cooperative combination with a second side body portion a seed deposition port, and further having a chute defining, in cooperative combination with said seed entrainment disc 5, said seed chute entry port;
a second side body portion having seed disc mounting race bore, a trigger pivot mounting bore, and in cooperative combination with said first side body portion a seed deposition port;
a trigger unit comprising a body, a pair of trigger pivots, a seed disc gear, and a return spring;
a seed entrainment disc having, in cooperative combination with said first side body portion, a plurality of seed pockets, a rotation gear, and a mounting shaft;
a seed hopper having a seed loading aperture; and
a locking tensioning knob;
thereby allowing for the repeated placement of single seeds into individual small tray cells, soil cubes and soil plugs.

6. The trigger activated hand seeder for repeatedly placing single pelleted and non-pelleted seeds into small tray cells, soil cubes, and the like as claimed in claim 5 wherein said seed entrainment disc has bearings mounting said seed entrainment disc to said first side body and said second side body portions.

7. The trigger activated hand seeder for repeatedly placing single pelleted and non-pelleted seeds into small tray cells, soil cubes, and the like as claimed in claim 5 wherein said hand seeder is composed of molded durable, ultraviolet resistant plastic resin materials selected from the group comprising polycarbonate, nylon, ABS, PVC, and Delrin.

8. The trigger activated hand seeder for repeatedly placing single pelleted and non-pelleted seeds into small tray cells, soil cubes, and the like as claimed in claim 5 wherein said seed entrainment disc in cooperative combination with said locking tensioning knob provides for rotation of said locking tensioning knob thereby providing a means to displace the trigger gear a sufficient number of cogs of said rotation gear allowing a desired seed pocket to be selected to receive seeds from said seed hopper.
